(19) United States
(12) Patent Application Publication
(10) Pub. No.: US 2009/0093901 A1
(43) Pub. Date: Apr. 9, 2009

(54) METHOD AND APPARATUS FOR USING DESIGN SPECIFICATIONS AND MEASUREMENTS ON MANUFACTURED PRODUCTS IN CONCEPTUAL DESIGN MODELS

(75) Inventors: Omar Awile, Zeurich (CH); Laurent Balmelli, Tokyo (JP); Fumihiko Kitayama, Kanagawa-ken (JP); Masayuki Numao, Kanagawa-ken (JP)

Correspondence Address: SCULLY, SCOTT, MURPHY & PRESSER, P.C., 400 GARDEN CITY PLAZA, SUITE 300, GARDEN CITY, NY, 11530, US

(73) Assignee: INTERNATIONAL BUSINESS MACHINES CORPORATION, Armonk, NY (US)

(21) Appl. No.: 11/866,782

(22) Filed: Oct. 3, 2007

(51) Int. Cl. G06F 19/00

(52) U.S. Cl. 700/97

(57) ABSTRACT

A system and method for using design specification and measurements on manufactured products in conceptual design model are provided. In one aspect, a conceptual model is extended to map one or more model elements to corresponding external reference values. The corresponding external reference values include at least design specification values and manufacturing properties associated with one or more model elements. The model elements mapped to corresponding external reference values are presented, for example, for identification and consistency checks of attributes at various stages of product life cycle.

### FIELD OF THE INVENTION

The present disclosure relates to method and apparatus for using design specifications and measurements on manufactured products in conceptual design models.

### BACKGROUND OF THE INVENTION

It is becoming increasingly difficult to execute and manage design and manufacturing processes of complicated products, like automobile vehicles, due to the tightly coupled various activities of various engineering disciplines such as machinery design, electronics design, and software design. Recently a trend has emerged, in which a system-level concept model is defined and used to manage these processes and artifacts in integrated fashion. An example of this concept is shown in OMG: SysML. Using such a concept model, it is possible to solve a number of problems caused as a result of complicated system components being tightly coupled with each other, and it is possible to enlarge communications among different disciplinary engineers. Consequently, high quality products can be released into the market place quickly.

However, there is no way to integrate various existing engineering master databases, such as product design database and bill of materials (BOMs), which are required for product design and manufacturing. There is also a lack of mechanism to collaborate on those components when a system engineer uses such a modeling language and tool, an example of which includes EmbeddedPlus: SysML Toolkit for RSDP. It is inefficient to transform the concept model in the upstream process into the design and manufacturing models in the downstream process. There is no systematic method of validating design changes and manufacturing changes on the concept model, and it is difficult to analyze faults identified in the production and market place by connecting real products to the system model.

In order to address the above problems, L. Balmelli: Generic Graphical Modeling Language Part I proposes that the system engineers who write the concept model access various design and manufacturing information in the BOM through Web services, but there has been no proposal as to how to access non-uniform distributed manufacturing data, which are not always mapped simply to system-level model elements one by one, and how to verify and trace various technical problems such as system-level requirements, satisfied design, and impacted portions due to faults and design changes.

The existing system engineering modeling tool such as a SysML tool, is effective only for development of the initial model and communication among a number of engineers of various disciplinary areas. But, such communication is just one way and there is no method of solving complicated problems related to various designs and manufacturing methods, which occur during detailed design, after finishing manufacturing preparation, and even after starting the production process.

When the system design concept model is created and/or modified, it is generally not easy to refer to or correlate other external data or reference values such as values obtained at manufacturing, production, or after sales stages. For instance, it is difficult to access system design and external values from each other because the system design computing environment is physically and technically different from those of detailed manufacturing design. For example, the system design workstation is located in the office area, but the computers in the production place are special machines that are not connected to each other.

It is also difficult to share design and manufacturing data because the system design organization may be separated from the production organization due to the organizational rules and corporate strategy. For example, as such data are confidential, they are strictly restricted to be accessed from the whole employee by a certain access control. The purchase order of parts in the production place cannot be accessed from system designers.

Furthermore, there is no explicit association between system design model elements and detailed manufacturing design data because the system design is automatically or manually transformed to detailed manufacturing design at many intermediate stages. In the system design phase, functionality may be focused as one model, but in the production place, it is transformed into many structured parts (bill of material), and the relationship between a function and a part is not always one-to-one.

Still yet, it is difficult to manage system level design data and detailed manufacturing data in the integrated way because they have quite different structure and reference method respectively according to each purpose: understanding and abstraction of the target system (system design) vs. various specific design and manufacturing purposes (detailed design and production). For example, model elements in the system-level design are described in order to understand the total product and also to abstract the target system. On the contrary, as detailed manufacturing design information has a different purpose, the information structure and the reference method are different from those of the system-based design. Accordingly, even if the association between the model elements in system-level design and the external reference values in the detailed manufacturing design is clarified, difficult still remains in finding inconsistency among the model, the information structure on the detailed manufacturing design, and the reference method.

### BRIEF SUMMARY OF THE INVENTION

A system and method for using design specification and measurements on manufactured products in conceptual design model are provided. The system in one aspect may comprise a conceptual model extender module operable to map one or more model elements to corresponding external reference values. The corresponding external reference values include at least design specification values and manufacturing properties associated with said one or more model elements. The system may also include a presenter module operable to present said one or more model elements mapped to corresponding external reference values and a importer module operable to import said external reference values from one or more external systems for mapping to said one or more model elements.

A method of using design specification and measurements on manufactured products in conceptual design model, in one aspect, may comprise extending a concept model to include mappings of one or more model elements to corresponding reference values, the corresponding external reference values including at least design specification values and manufacturing properties associated with said one or more model elements. The method may also comprise importing said corresponding external reference values from one or more external systems for mapping to said one or more model elements and presenting said mappings of one or more model elements to corresponding reference values to a user.

A program storage device readable by a machine, tangibly embodying a program of instructions executable by the machine to perform above described method may also be provided.

Further features as well as the structure and operation of various embodiments are described in detail below with reference to the accompanying drawings. In the drawings, like reference numbers indicate identical or functionally similar elements.

### BRIEF DESCRIPTION OF THE DRAWINGS

FIG. 1 is a system composition diagram in one embodiment of the present disclosure.

FIG. 2 illustrates a display example of external reference values using stereotype names.

FIG. 3 illustrates a display example of external reference values using visual icons.

FIG. 4 illustrates an example trace of sensor use requirements of windshield to the sensor design specification values.

FIG. 5 illustrates an example display of design and manufactured values using separated compartments.

FIG. 6 illustrates a display of design and manufactured values in SysML.

FIG. 7 illustrates an example of usage of the satisfy relationship in a SysML diagram.

FIG. 8 illustrates SysML extensions for the satisfy relationship in one embodiment of the present disclosure.

FIG. 9 illustrates a flowchart for mapping activity of system engineer in one embodiment of the present disclosure.

FIG. 10 illustrates an example of a mapping GUT (graphical user interface) used to map the concept model to the external reference values.

FIG. 11 illustrates an example of a GUI used to select mapped external components as design specification values.

FIG. 12 illustrates an example GUI that allows a user to import various measured values at production time.

FIG. 13 illustrative an example of patterns for inconsistent mapping.

FIG. 14 illustrates an example algorithm of detecting mapping inconsistency.

FIG. 15 shows three extended meta classes from SysML::Dependency.

FIG. 16 illustrates creating a dependency between design and manufacturing properties in one embodiment of the present disclosure.

FIG. 17 illustrates a flow chart for synchronizing among different properties in one embodiment of the present disclosure.

FIG. 18 illustrates a flow chart for refining system concept model in one embodiment of the present disclosure.

FIG. 19 illustrates a display in one embodiment that may be provided in the method, system and apparatus of the present disclosure that allows for directly comparing design and manufacturing values in the conceptual model of the present disclosure.

FIG. 20 shows an example of traceability between the product requirements to values from the design and the manufacturing stages.

FIG. 21 illustrates an example use of extended satisfy associations.

FIG. 22 illustrates a simplified example of the data structure and hierarchical relationship for the bill of material in one embodiment.

### DETAILED DESCRIPTION

The disclose method, system and/or apparatus enable efficient usage of external reference values in the downstream process from system-level concept model. The method and tool are described that relate to how to access the data, how to collaborate on them, and how to verify them in order to efficiently use the external reference values in the detailed-manufacturing process in the downstream process when the system-level concept model is created and modified.

In one aspect, the concept model refers to an abstracted description about the requirements, functions, and behavior of the manufacturing product instance as a total system. Its roles are to coordinate different disciplinary engineering processes of the system and to verify the simulated behavior. More concretely, it is created in the upstream process of the development by a modeling tool, and it is used to generate design and manufacturing directives in the downstream process. The external reference values refer to various engineering property values about technical feature values, quality related statistics, and so on, about the used parts and production method for the targeted manufacturing product. They are stored in the existing manufacturing database systems, for example.

The disclosed method, system and apparatus addresses the difficulties encountered with existing design concept models. For example, the method, system and apparatus of the present disclosure in one embodiment addresses importing data from the downstream process into the modeling tool, building associations between the data and the system model (a method of specifying the associations and representing the structure), presenting and/or or displaying the associations on the diagrams of the modeling tool, and modifying and verifying the system design using such data.

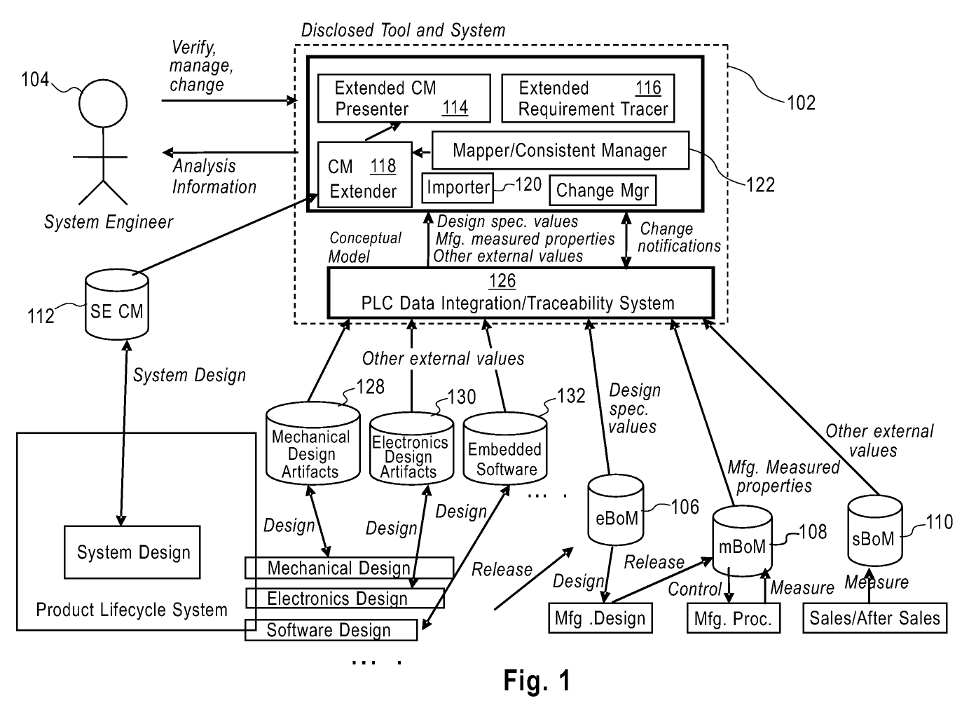

The disclosed method, system and apparatus in one embodiment extends the concept model to provide a tool that can import and map the data from various detailed design and manufacturing data. FIG. 1 is a system composition diagram in one embodiment of the present disclosure. A proposed tool and data system of the present disclosure in one embodiment are shown in a dotted rectangle 102. A user 104 manipulates the tool 102 interactively and imports various BOM data (e.g., 106, 108, 110, etc.) and the original system engineering concept model SE CM 112. The tool 102 may be extended from an existing modeling tool for the SE CM 112. The tool 102 may include (1) a module extending the concept model, (2) a data system uniformly accessing and tracing various product data, (3) a module importing the external data to the model and managing mappings and consistency, and (4) a module presenting the integrated model to users.

A method is also provided for mapping and storing complicated many-to-many associations between the concept model and detailed manufacturing design data. Another procedural method is provided for importing the external data, such as BoM (bill of material) data, and of verifying the consistency. A useful application is also disclosed of the extended system model of the present disclosure with the mappings to various activities in the design and production process.

The tool of the present disclosure creates and modifies the concept model of the system design. For example, the tool imports external reference values, which are useful for improvement and verification of the concept model, for instance, by abstracting and federating heterogeneous data in different computer systems. The tool includes extended data representation to maintain associations between the model elements and BOM parts based on the original model structure (metamodel) in order to associate external reference values in the BOM with elements of the model. The tool may also include a user interface, which enables users to import the BoM structure and data from external databases and to select the corresponding model elements to them in order to specify the associations. Based on the data representation, for example, described above, a method of displaying external reference values and BoM parts on the model diagram other than the concept model elements may be implemented in the program code of the tool. The method enables users to easily create and improve the system design by simultaneously looking at the model elements and the external reference values.

Using the above-described associations, the system, method and apparatus of the present disclosure also presents a program code that traces the requirement associations (“satisfy” association) by extending the existing associations, and a program code that enables to find inconsistency between system design constraints and external reference values. The system, method and apparatus of the present disclosure enables to identify and improve a number of problems caused at the system design, detailed design in the downstream process, and manufacturing design in the further downstream process.

The tool may further implement a program code to identify a pattern of the mappings related to structure of the system design elements and BoM, and a program code that validates associations on the pattern by rues checking the inconsistency. These implemented functions contribute to increase reliability of the tool by validating user's data imported by hand.

Referring to FIG. 1, a presenter module 114 presents mapped external reference values, such as design specification values, measured values in the production time, and so on, with appropriate data types to users. The design specification values are determined in various design activities, such as mechanical design, electronics design, software design, and so on, stored in respective databases or like 128, 130, 132, for example. Examples of design specification values may be physical sizes, such as length, thickness, pressures, and voltages. Measured values in the production time are collected as various test results (e.g., tolerance values, failure rate, dispersions, and so on), for example, shown at 108, which are considered important information for the system engineering. Generally, other external values such as manufacture design parameters or attributes 106 and/or values related to sales and/or after sales activities may also be collected. Data integration and traceability system module 126 interfaces to such external reference values.

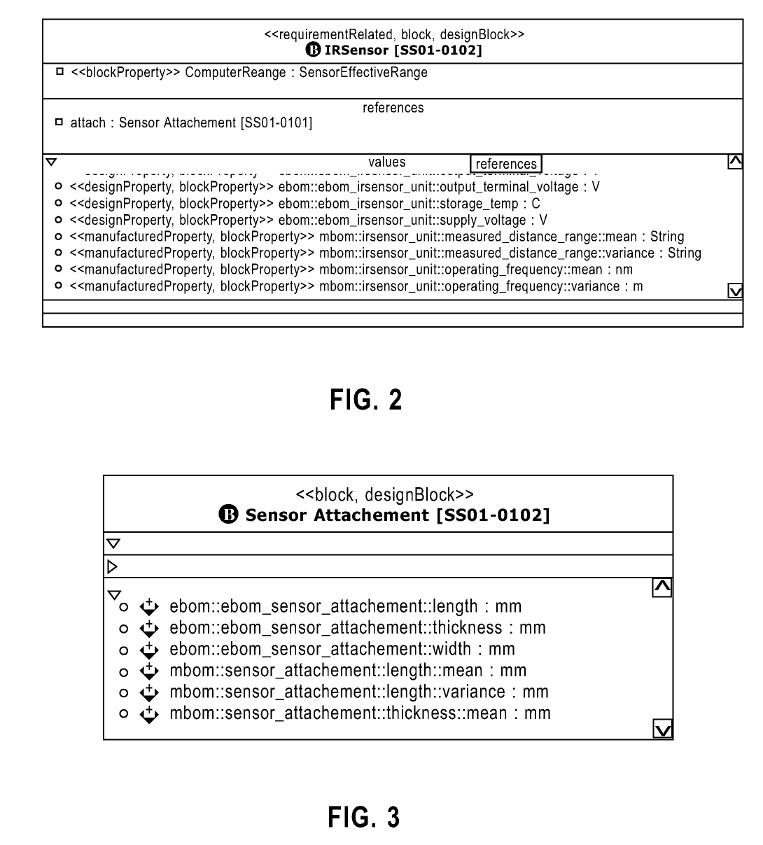

In one embodiment, such external reference values can be indicated by attaching special text strings, like “<design property>” and “<manufactured property>” (see FIG. 2, or visual icons in FIG. 3) before property text strings in the model element. The tool in one embodiment differentiates the new properties imported from the external system from the original properties in the concept model. For example, blocks and objects in SysML and UML are displayed in separated boxes with new compartments that include such properties as different groups.

According to user's instruction, such new properties from external systems may be highlighted or hidden. As a result of the display, a user can refer to product life cycle data, such as design specification values related to the system concept model at once. A user can detect inconsistency of the data with the system concept model, can improve the product, and even can solve the several problems that may have occurred in the design and manufacturing processes, for instance, perform a root cause analysis about fault parts and quality control.

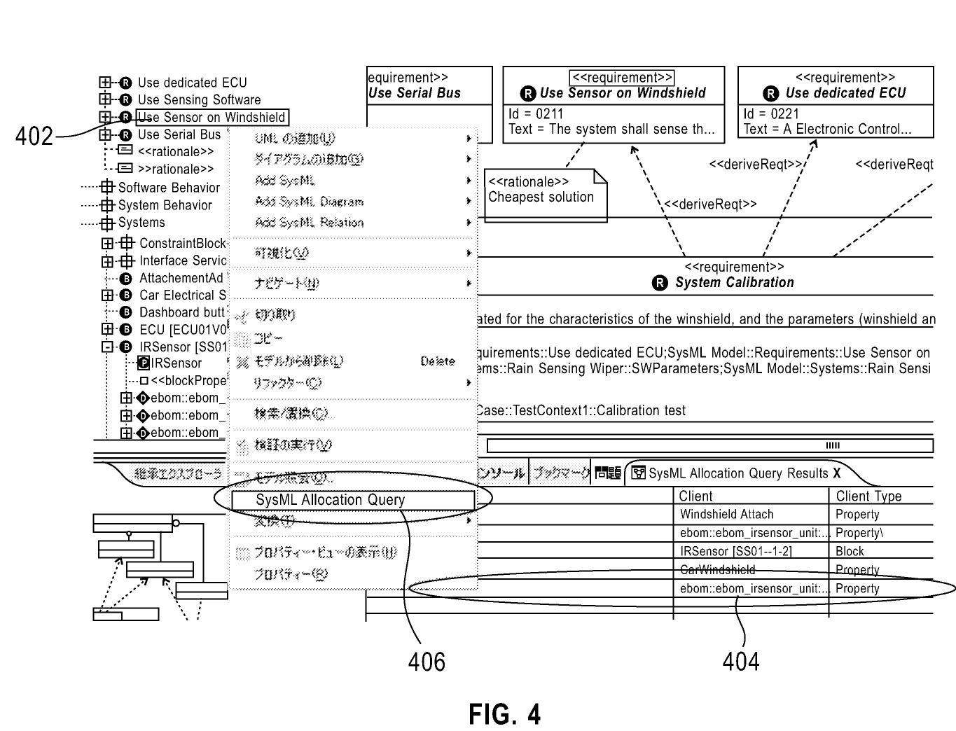

In general, the system concept model enables to trace requirements to the satisfied elements by defining an association between them. The method, system and/or apparatus of the present disclosure implements an extended requirement tracer 116 that extends the existing “Satisfy” association to trace requirements to external reference values, such as design specification, which satisfies the requirement. For instance, on a user interface such as the one shown in FIG. 4, a user may perform right-click on a graphically displayed requirement (for example, represented by a tree node, “Use Sensor on Windshield 402 in FIG. 4) and select a menu in the context menu to invoke Tracer. For example, a user may select “SysML Allocation Query” menu item 406. The invoked Tracer presents satisfied design specification values by tracing the extended Satisfy associations for instance as shown in FIG. 4. The user can verify if the requirements are satisfied extendedly through the whole product life cycle, other then only at the concept level. In FIG. 4, the requirement, “Use Sensor on Windshield” is satisfied by an engineering reference value “ebom:ebom_irsensor_unit” 404.

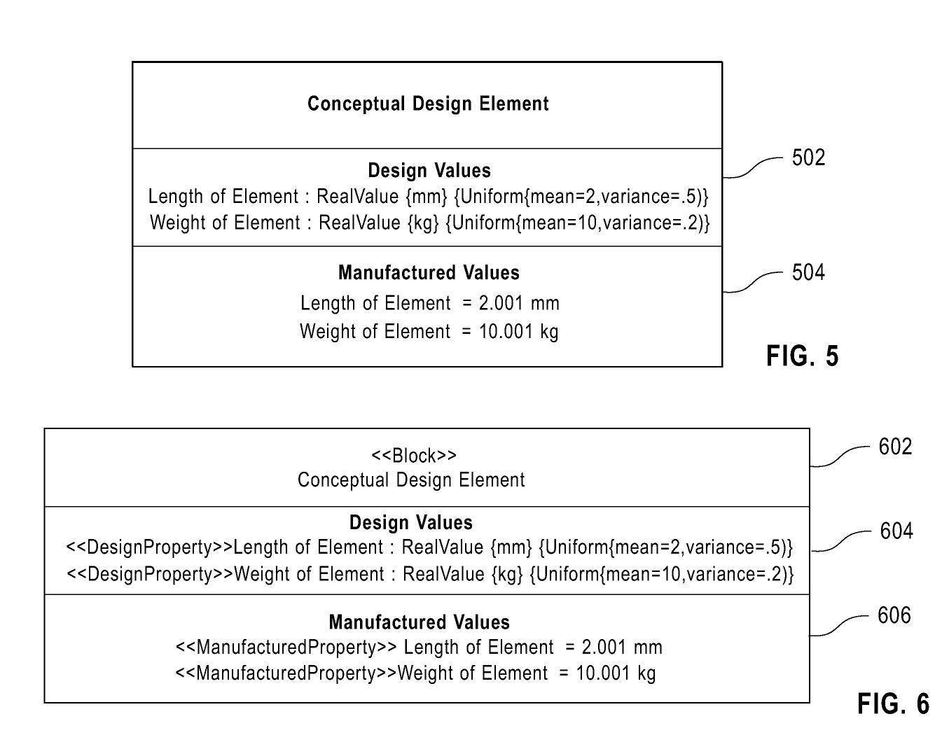

Extender 118 extends the notation of the conceptual model. The design and manufactured values are represented differently from values not imported from the BoM. For example, the display of the manufacturing properties can be done separately from the other design values of the conceptual design element. FIG. 5 illustrates an example display of design and manufactured values using separated compartments. Design values and manufactured values are shown in different compartments 502, 504.

In an embodiment that uses SysML as a conceptual modeling language, the metaclass block 602 represents the conceptual design element, as illustrated in FIG. 6. One of the roles of the conceptual design model is to maintain traceability between the product requirements and the compartment in the conceptual design model that satisfy them. In another embodiment, the method, system and apparatus of the present disclosure trace the satisfaction from the requirements to the design and manufactured properties. The traceability can be stored using tables in a database, for example jointly to the Bill of Materials (BoM). FIG. 6 illustrates an example display of design and manufactured values 604, 606 in SysML.

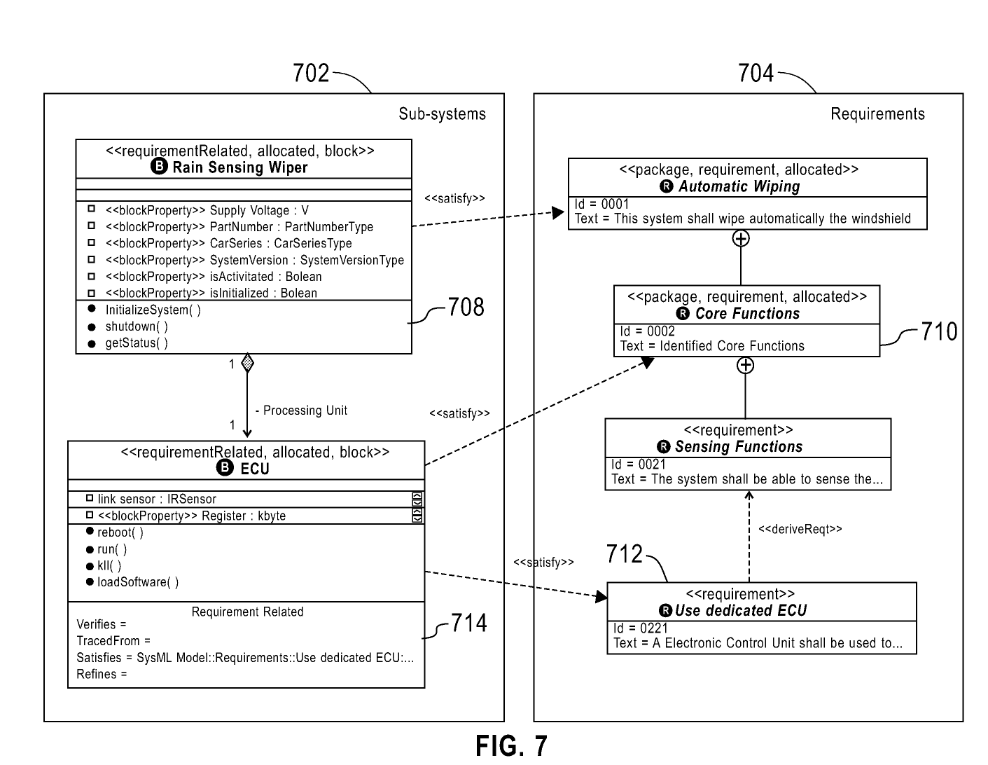

In an embodiment that uses SysML, the method, system and apparatus of the present disclosure may extend the semantic of the satisfy relationship in the language. The satisfy relationship is used to connect requirement elements to other model elements that satisfy them. An example is shown in FIG. 7. FIG. 7 illustrates an example of usage of the satisfy relationship in a SysML diagram. For instance, designed system components 702 can be compared with their respective requirements 704 using the satisfy relationship. A requirement “Automatic Wiping” should be satisfied by a system component “Rain Sensing Wiper,” and similarly, two requirements “Core Functions” 710 and “Use dedicated ECU” 712 should be satisfied by system component “ECU” 714.

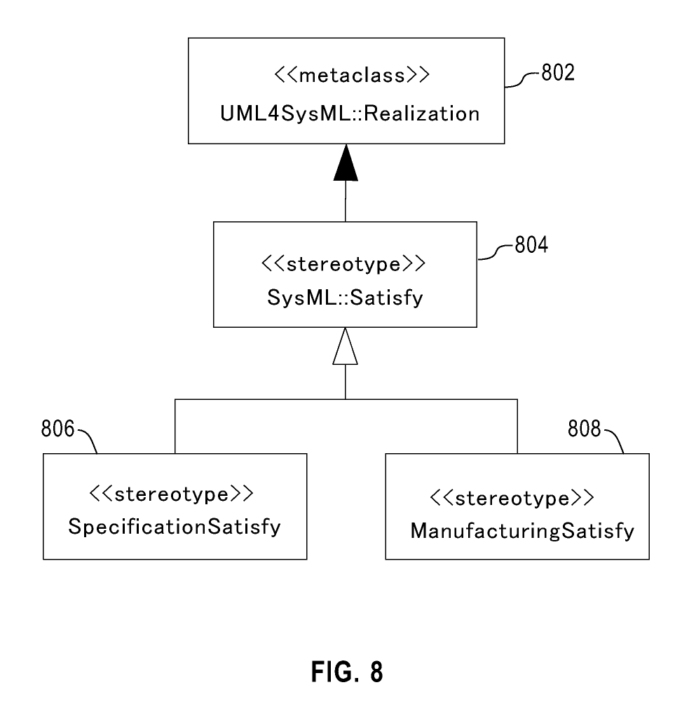

The method, system and apparatus of the present disclosure in one embodiment refine the semantics of the relationship to distinguish between satisfaction by design specifications and satisfaction by manufactured properties. The distinction is useful because these properties emerge at very different stages of the lifecycle. Differentiating between them allows the stakeholders to have a better understanding of the product from a requirement satisfaction standpoint. It is common that a manufacturing product diverges from its specification. Hence even though a product design might fulfill the requirements, its manufactured counterpart might present unexpected issues. The metamodel extensions in one embodiment in SysML are presented in FIG. 8. The notation used here pertains to the Unified Modeling Language and the use of the profile extension. The two boxes labeled by “SysML4UML:Realization” 802 and “SysML: Satisfy” 804 in FIG. 8, which both are defined in the SysML specification, can be extended by the method of the present disclosure into two different specialized relations: SpecificationSatisfy 806 and ManufacturingSatisfy 808. SpecificationSatisfy 806 describes the satisfied system components that are system-level specifications, and ManufacturingSatisfy 808 describes the satisfied system parameters that are determined at design or manufacturing time.

Referring back to FIG. 1, importer 120 imports various product lifecycle data, such as design specification values, measured values at production time, and so on. At this time in one embodiment, names of properties and names of blocks, which contain the properties, other than actual values, are also imported simultaneously in order to realize various mappings. Real external data may have different schema definitions, need to be traced through a complicated network, or reside in databases at different platforms. Consequently, a data system, which integrates data from different origins and a traceability system may be used to import the data. Such a system can be considered as a uniform database system having various external reference values in this disclosure.

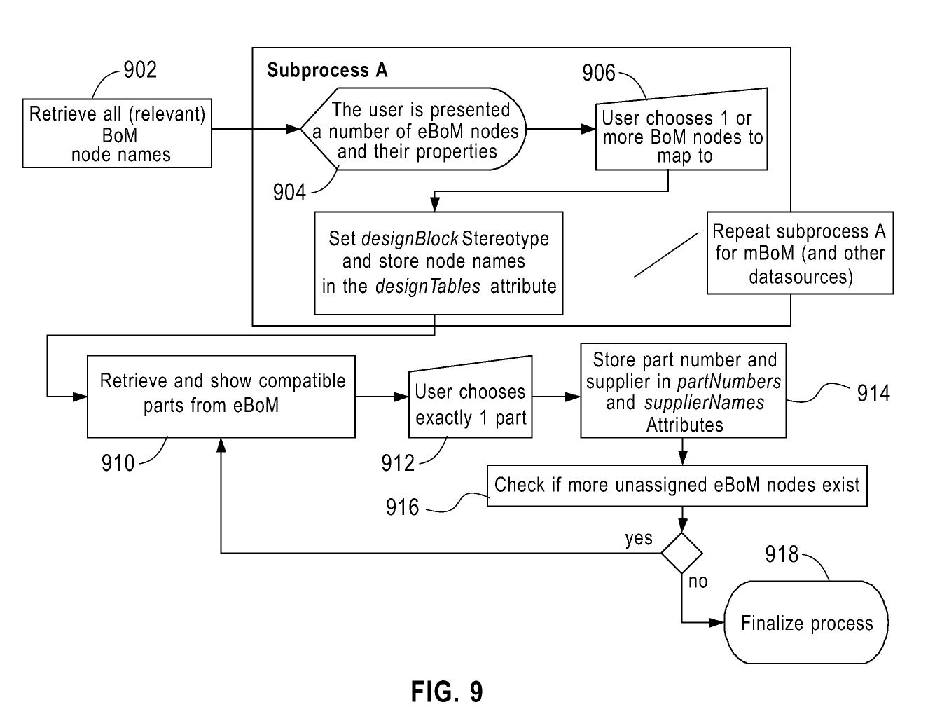

Importer 120 can perform aggregation, which calculates average, variance, etc. as one of measured values. Importer 120 may include a function to display a histogram for each ranged data. Such analytical data are useful to find and solve various problems that occur during the product lifecycle. For example, importer 120 may have a GUI function to display a list of importable properties and values in order to let a user specify imported properties and values. FIG. 9 illustrates a flowchart describing the interactive procedure in one embodiment.

FIG. 9 illustrates a flowchart for mapping activity of system engineer in one embodiment of the present disclosure. At 902, bill of material (BoM) node names are retrieved. At 904, the user is presented a number of eBoM nodes and their properties. At 906, user selects one or more BoM nodes to which to map. At 908, attributes of the selected node is set and stored, for example, designBlock stereotype is set and the nodes names are stored in the designTable attribute. At 910, compatible parts from eBoM are retrieved and presented to the user. At 912, user selects one part. At 914, information associated with selected part is stored, for instance, part number and supplier are stored in partnumbers and supplierNames attributes. At 916, it is determined whether there are unassigned eBoM nodes. If there are more unassigned eBoM nodes, the logic returns to step 910, otherwise, the process is finalized at 918.

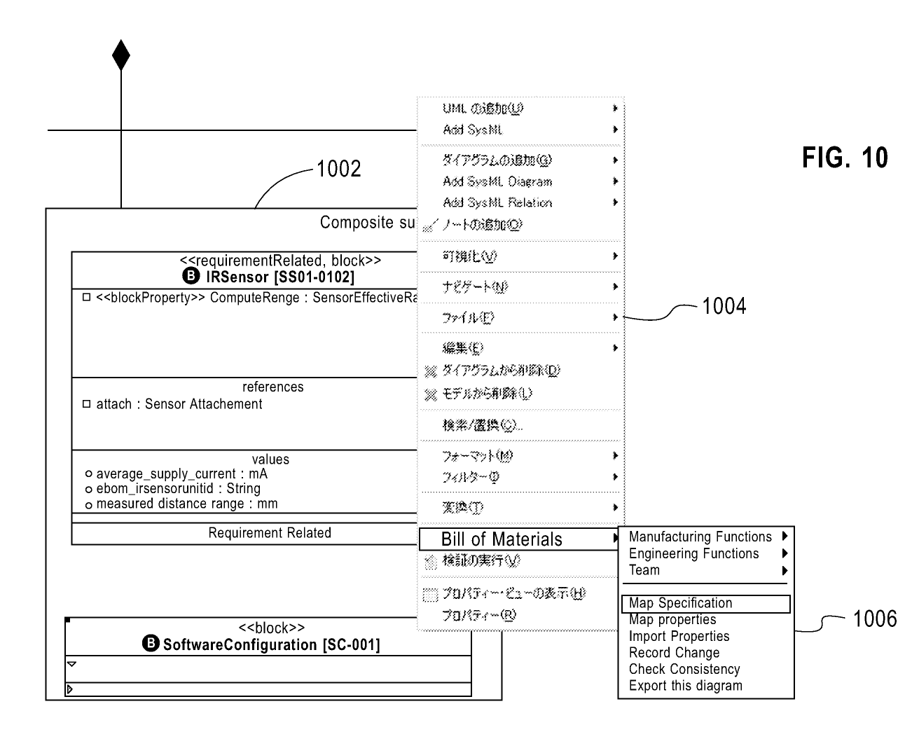

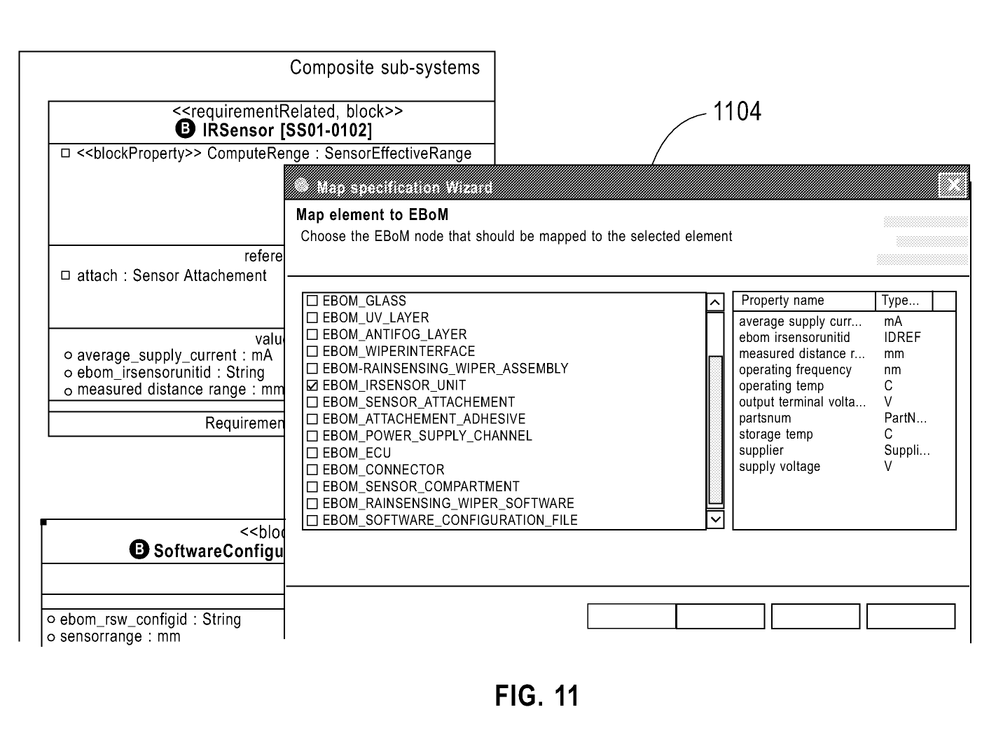

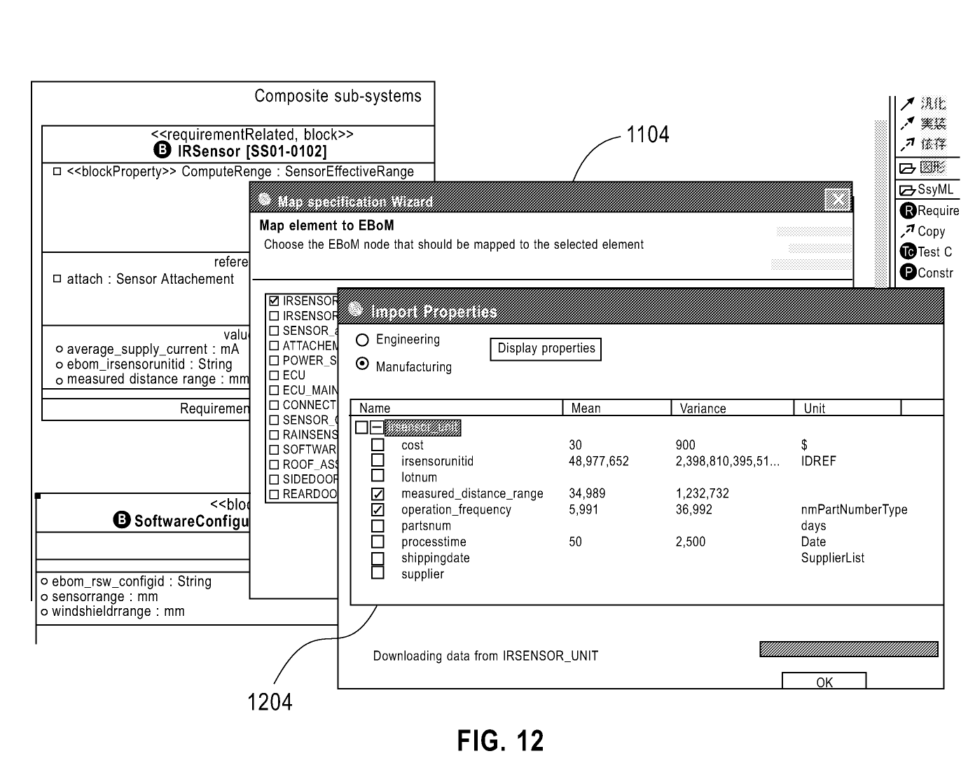

To import actual values, a concept model element is specified to be mapped from the imported properties, for instance, shown in FIG. 10. From a concept design element view or display pane 1002, a user may be able to map the element to the imported properties by right-clicking on the pane, a button, or like functionality to specify a mapping. A pop-up menu 1002, 1004 may allow the user to perform the mapping. In a GUI dialogue as shown in FIG. 11 and FIG. 12, for example, selections of importable properties may be displayed after specifying a category of the imported external reference value. A user may select one or more eBoM nodes to select from the display 1104. Import properties may be mapped using the selection menu 1204, for example, shown in FIG. 12.

At this time it is possible to restrict the number of displayed properties at once by selecting blocks, objects, or categories, which contain the properties. A user may confirm and transfer the property values to Mapper (FIG. 1, 122) with names of blocks or objects, which contain the properties. Furthermore, it is possible to select and import multiple values at once in order to enable one-to-many mappings. Mapper (FIG. 1, 122) may be invoked with the mapped element of the concept model. FIG. 10 illustrates an example of a mapping GUI (graphical user interface) used to map the concept model to the external reference values. FIG. 11 illustrates an example of a GUI used to select mapped external components as design specification values. FIG. 12 illustrates an example GUI that allows a user to import various measured values at production time.

Referring back to FIG. 1, a Mapper 122 builds mappings between the element names of the concept model and the property values transferred from Importer 120 based on the extended model definition by CM Extender 118. It can be implemented by introducing the data structure to hold model elements, like blocks, containing external reference values into the concept model. The data structure in one embodiment holds set values representing multiple property values in order to realize one-to-many mappings. In one embodiment, the imported properties are mapped not only to elements of the concept model but also to other imported properties.

For example, Satisfy association (which specifies a concept model element as a target and a requirement as a source, and which enables the trace of the requirement blocks to satisfied things) can be extended to realize new mappings between the imported properties and the concept model elements. More detailed method of extending the model and of specifying the mappings are described above with reference to CM Extender 118. The extended Satisfy association may be also used in the traceability function.

In one embodiment, the extended mappings among imported properties can be implemented by using the native association mechanism of the modeling tool because the imported properties are handled as the native properties. Such a mapping enables to manage consistency between two related external reference values. It is possible to check if such consistency is kept or not through satisfaction of the constraint expression, which is annotated at the mapping.

In one embodiment, Consistency Manager 122 requires at least two elements in different models to be synchronized using Mapping structure. This manager 122 is used when at least two elements in each model have been synchronized. In one embodiment of the present disclosure invention, CM (conceptual model) is described using SysML and the EM (engineering model) has an instance of a Bill of Material.

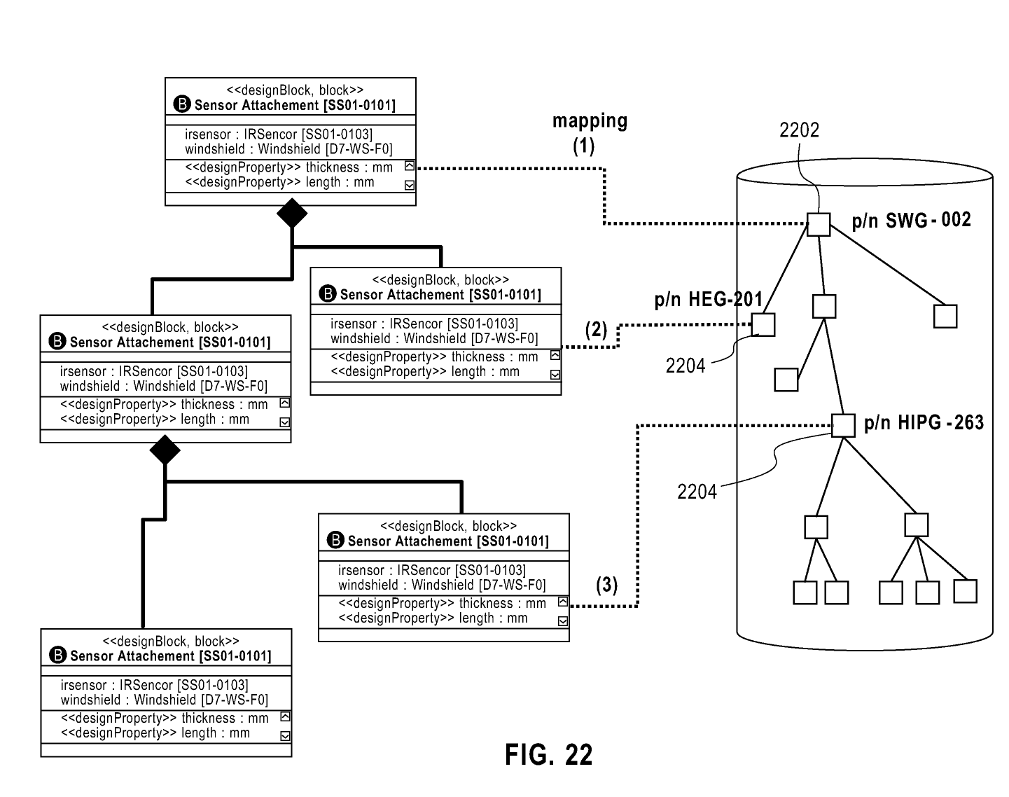

A simplified example of the data structure for the bill of material is shown in FIG. 22. In the implementation of this embodiment, the models use a hierarchical relationship in order to describe composite (e.g., tree-like) structures between the elements. In the example of FIG. 22, the element p/n SWG-002 (2202) has elements (among others) HEG-201 (2204) and HIPG-263 (2206). This rule ensures that such a relationship is not in contradiction, through the mapping, with an equivalent relationship in the model where the elements are mapped.

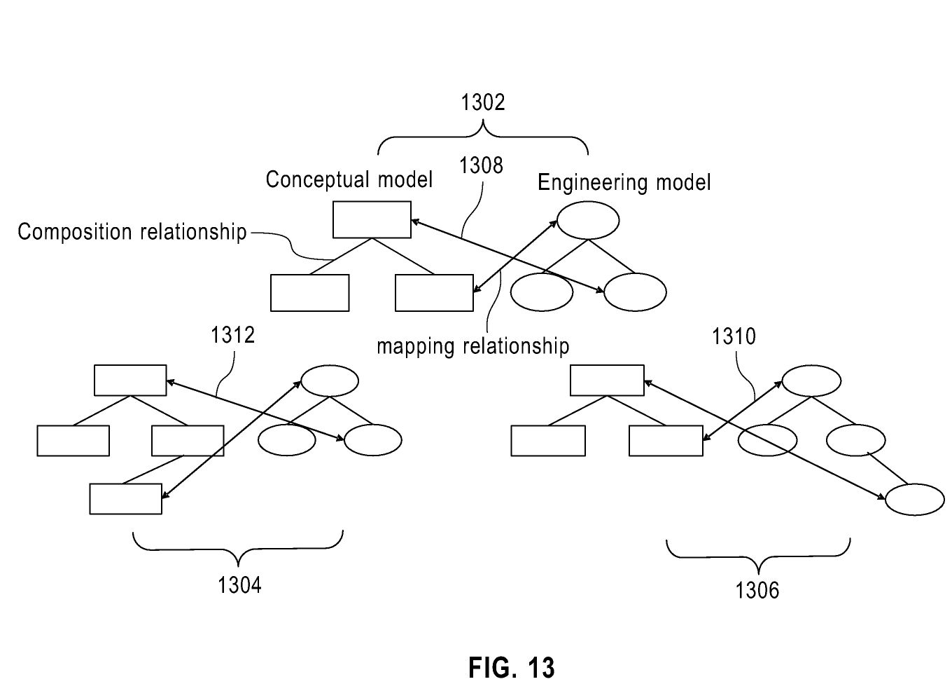

To illustrate how contradictions can be reached, FIG. 13 shows three cases. FIG. 13 illustrates an example of patterns for inconsistent mapping. This figure shows three cases of contradictions when using the composition relationship. Three cases can be recursively combined to obtain more complex cases of contradictions. A case of contradiction results if the hierarchy structure, that is, parent-child orders, of the mapped elements are different from that of the original elements. In the FIG. 13, mapping relations in the three cases 1302, 1304, 1306 represented by arrow lines cross each other shown at 1308, 1310, 1312. Contradiction case means that the realized structure or engineering model is not consistent with the conceptual model structure.

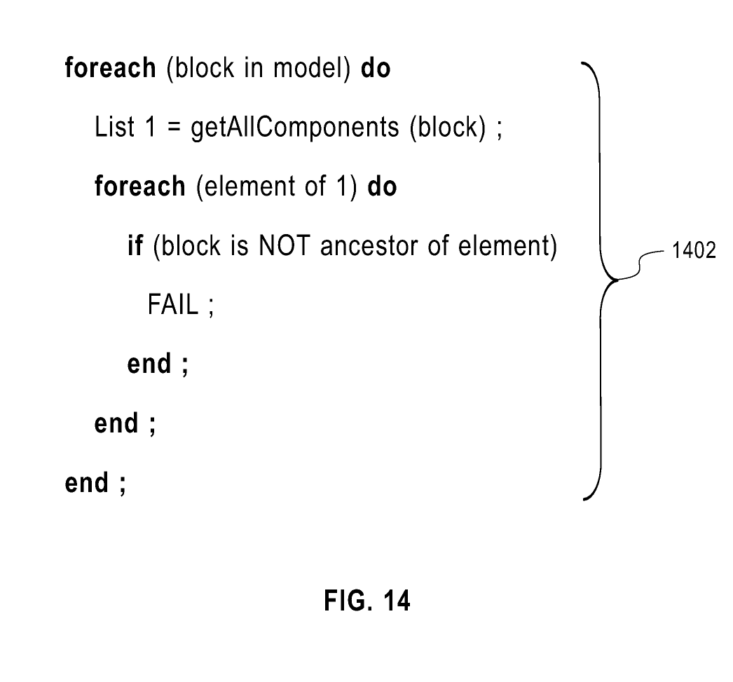

FIG. 14 illustrates an example algorithm of detecting mapping inconsistency, for instance, which enforces that the mapping conforms to the rules. In the algorithm 1402, for all composed blocks of an arbitrary block, the algorithm checks if the block is an ancestor of the each composed block or not. “Ancestor” means that the mapped element from the block is an ancestor of the mapped elements from the composed blocks. If any relation of the mapped elements violates this rule, the algorithm reports them as contraction cases.

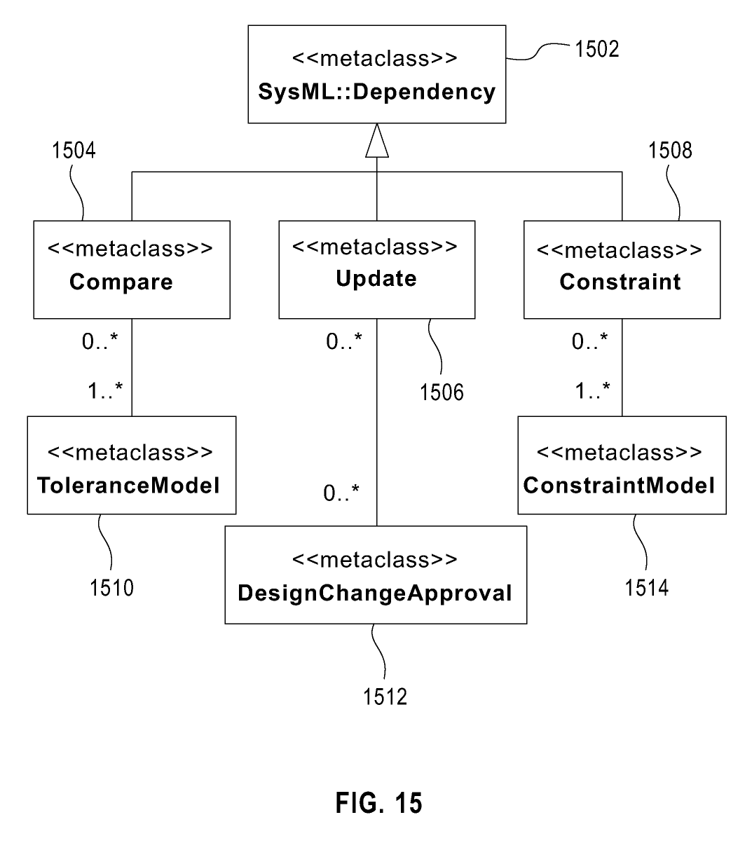

In one embodiment, Change Manager (CM, FIG. 1, 124) requires two elements in different models to be synchronized using Mapping structure, as well as two properties in this element to be related using Importer. In one embodiment of the present disclosure, CM is described using SysML and the EM has an instance of a Bill of Material. A simplified example of the data structure for the bill of material is shown in FIG. 15. In this implementation, SysML::Dependency 1502 is subtyped into three examples of relationships between properties. The semantics of each relationship is refined with an element that provides more information, for example, about the implementation of the relationship. FIG. 15 shows three extended meta classes from SysML::Dependency. Roles of these relationships are described below.

Compare 1504: This relationship compares the values between the properties in the two models. For example, a user can use this relationship to compare if the values of the properties are within a certain tolerance, specified in ToleranceModel metaclass 1510. A useful application of this relationship is between values of a specification (in the conceptual model) of the effective values obtained in the manufactured product.

Update 1506: This relationship is used to create dependencies between attributes and how values are dependent on each other. The relationship is used such that whenever the value in any of the properties is changed, the value in the dependent property is changed appropriately or marked as outdated. Update 1506 relationship may in turn depend on whether a change has been approved, for example, specified in DesignChangeApproval metaclass 1512.

Constraint 1508: This relationship is used to create constraints between properties. The nature and the implementation of the constraint 1514 may be left to the user.

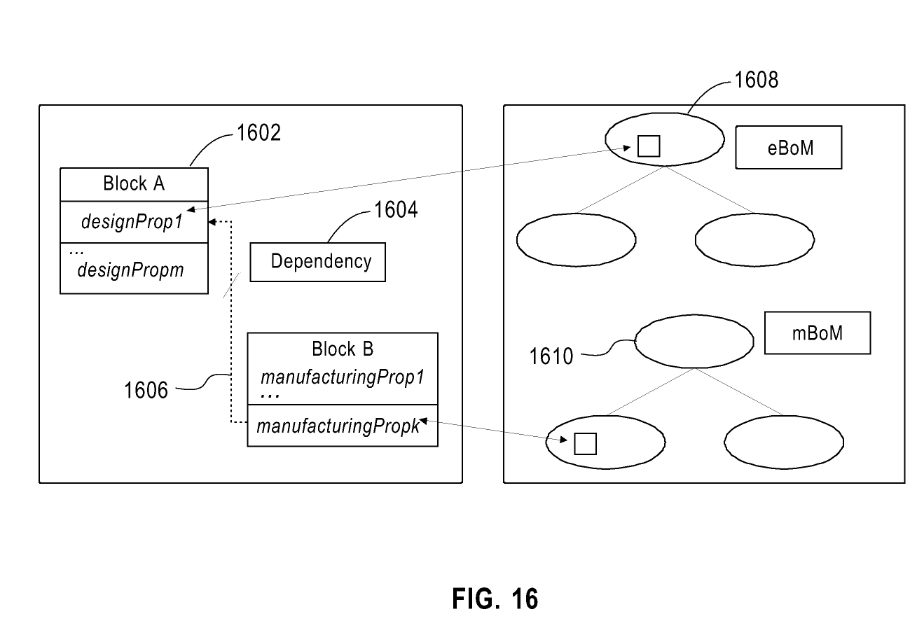

FIG. 16 illustrates creating a dependency between design and manufacturing properties in one embodiment of the present disclosure. The dependencies between the properties are kept in synchronization. For instance in FIG. 16, blocks in conceptual model, 1602 and 1604, which are synchronized with design properties in eBoM, 1608, and manufacturing properties in mBoM, 1610, respectively, maintain dependency links 1606.

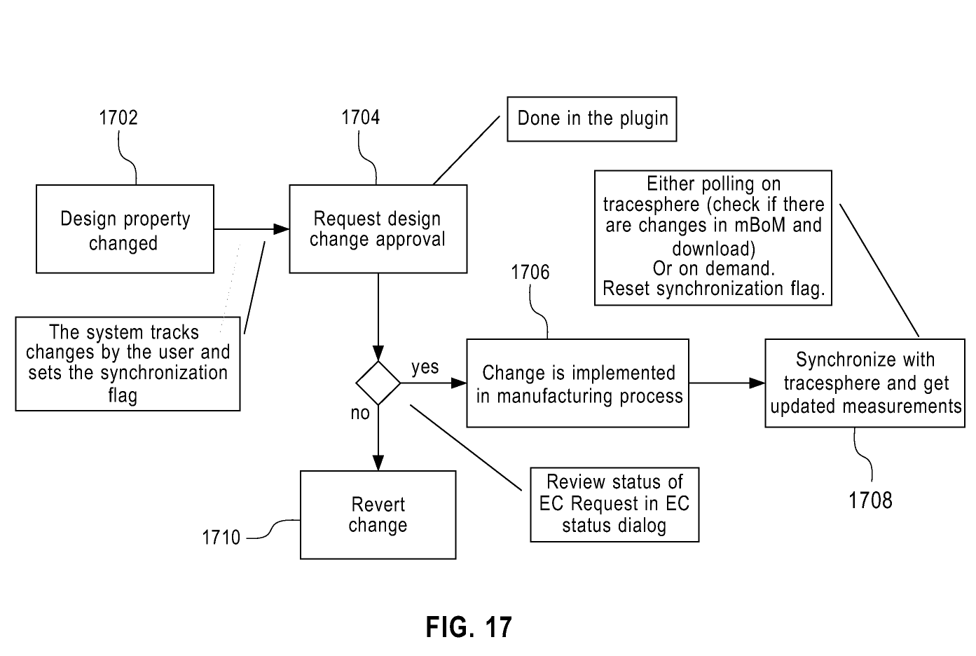

FIG. 17 illustrates a flow chart for synchronizing among different properties in one embodiment of the present disclosure. At 1702, it is determined that there is a property change in design data or attributes. For instance, the tool of the present disclosure or an auxiliary system or module may track changes by the user and set one or more synchronization flags. At 1704, design change approval is requested. Such request may be performed using a plug-in tools. At 1706, if the design change is approved, the change is also implemented in manufacturing process. At 1708, the tool synchronizes the change with a traceability system and gets updated measurements. This may be performed, for example, by polling the tracebility system to check if there are changes in mBoM and downloading the changes. In another embodiment, this may be performed on demand, for example, when the change occurs. After synchronization completes, the appropriate one or more synchronization flags are reset. At 1710, if the design change is not approved, the design change is rolled back. A project manager may review the ongoing EC status including the approval result using a GUI to display the status.

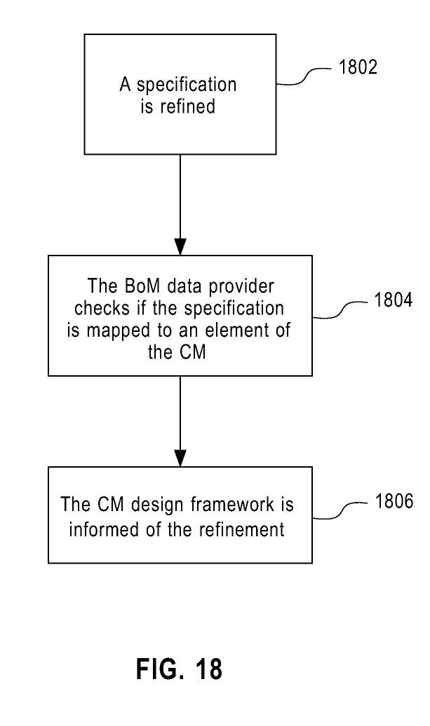

The information in the engineering model can be subject to modifications. In one embodiment of the present disclosure, such modification may be propagated to the conceptual model, for example, in the form of change notice. The notice would inform the conceptual designer that a refined specification is available for the conceptual element mapped to the engineering element that has been modified. FIG. 18 illustrates a flow chart for refining system concept model in one embodiment of the present disclosure. At 1802, it is determined that a specification, for instance, an engineering specification, is refined. At 1804, a BoM data provider checks if the specification is mapped to an element of CM. BoM data provider may be a manufacturing engineer who designs or determines what parts are used for this system. BoM data provider also may modify part specification at 1802. At 1806, the CM design framework is informed of the refinement, for instance, by a BoM data provider or manufacturing engineer. The tool of the present disclosure in one embodiment performs notification of the refinement to CM, at step 1806 automatically.

The integrated tool described in this disclosure enables to perform root cause analysis, to validate the solution, to identify the impacted portion of the changes, and to manage the change process due to one or more problems. For example, design change of electronics causes impact to mechanical design and/or software design, or, a problem on manufacturing technology causes system-level design changes, etc. The integrated tool described in this disclosure synchronizes such impacts and changes.

The method, system and apparatus of the present disclosure can be useful in many different scenarios of concrete usage, some of which are enumerated below.

Verification of Properties' Tolerance

The comparison between the specified values and the measured values in the manufactured product allows the stakeholders to insure that the manufactured product meets the product requirements. The method, system and apparatus of the present disclosure allow a conceptual model to be used as a repository for both design and manufacturing values and hence for their direct comparison. In one aspect, the conceptual design model offers a unique framework for this usage because it represents the product at the level of its subsystems. Hence a similar approach based on engineering data models used at later stage (e.g., in the Bill of Materials) would not allow for such a discipline-agnostic, systems-oriented representation because BoM has only manufacturing values and does not have specified values in CM. Other discipline specific designs, such as mechanical design, electronics, and embedded software, are the same. Only CM can have various engineering values in a consistent manner.

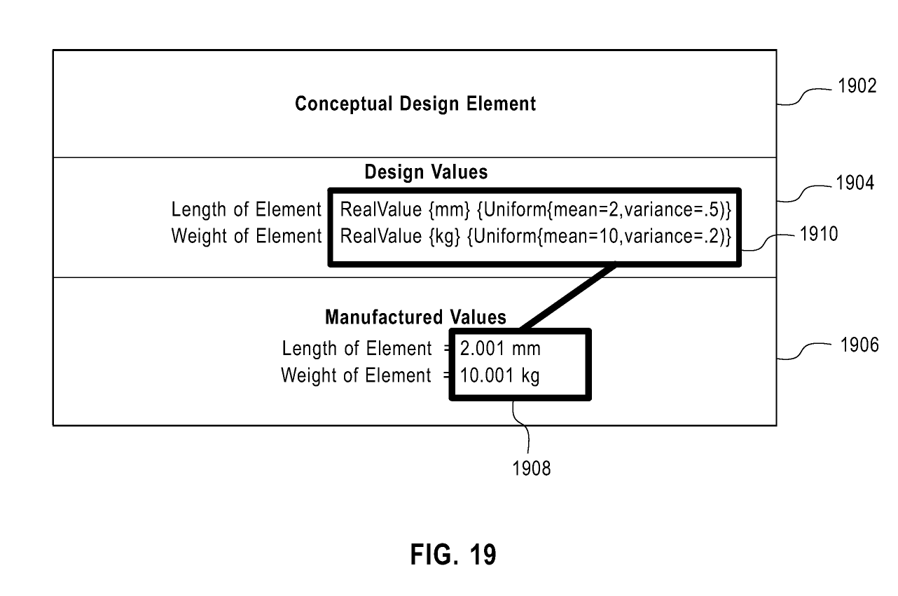

FIG. 19 illustrates a display that may be provided in the method, system and apparatus of the present disclosure that allows for directly comparing design and manufacturing values in the conceptual model of the present disclosure. Conceptual model of the present disclosure may provide a view of a conceptual design element 1902 in terms of both design values 1904 and manufactured values 1906. A user can then easily verify that the manufactured values 1908 conform to the design requirements 1910.

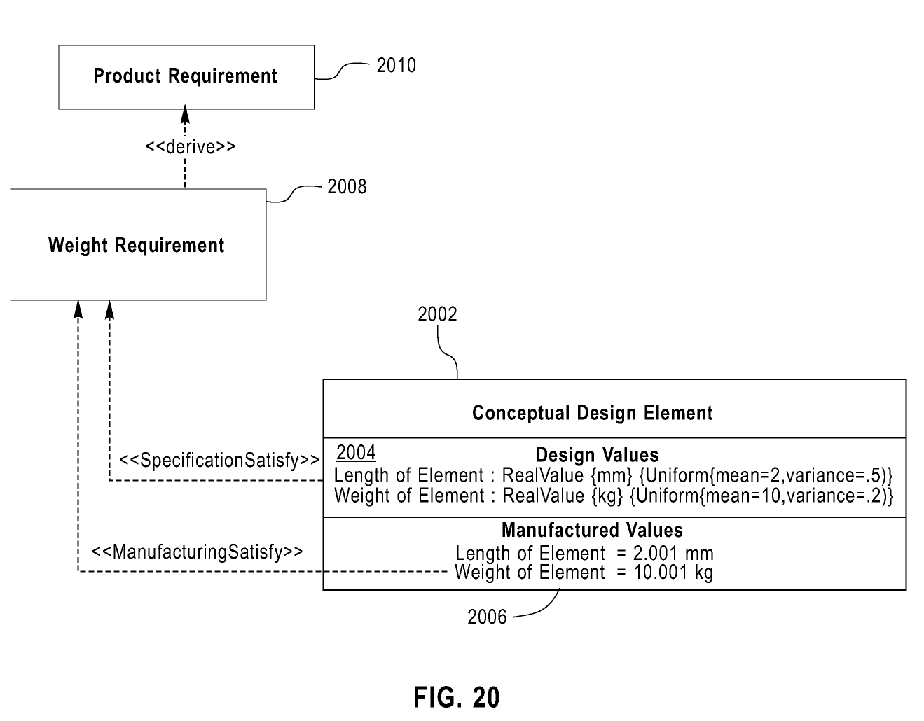

Requirement Verification against Manufactured Properties' Measurements A conceptual design model allows the inclusion of the product requirements in the model and therefore their traceability to the system components. Using the method, system and/or apparatus of the present disclosure, designer can trace satisfaction throughout the later engineering stages by monitoring the design and manufactured properties. Furthermore, the refinement of the satisfy relationship allows designer to further improve this monitoring process. FIG. 20 shows an example of improved traceability between the product requirements to values from the design and the manufacturing stages. In the example, a requirement on the weight of the product is traced to both design and manufactured properties. Both traces are used to monitor the product status at very different stages of its lifecycle. Design values 2004 associated with conceptual design element 2002 may be traced to determine whether those values satisfy the weight requirement 2008 and product requirement 2010. Similarly, manufacturing values 2006 associated with conceptual design element 2002 may be traced to determine whether those values satisfy the weight requirement 2008 and product requirement 2010.

A Posteriori Elicitation of Specification based on Manufactured Properties' Measurements

The access to manufactured properties at the conceptual stage creates a feedback loop that offers opportunities to refine the product specification. Using the method, system and/or apparatus of the present disclosure, designers can query the manufactured product for properties not included in the current specification.

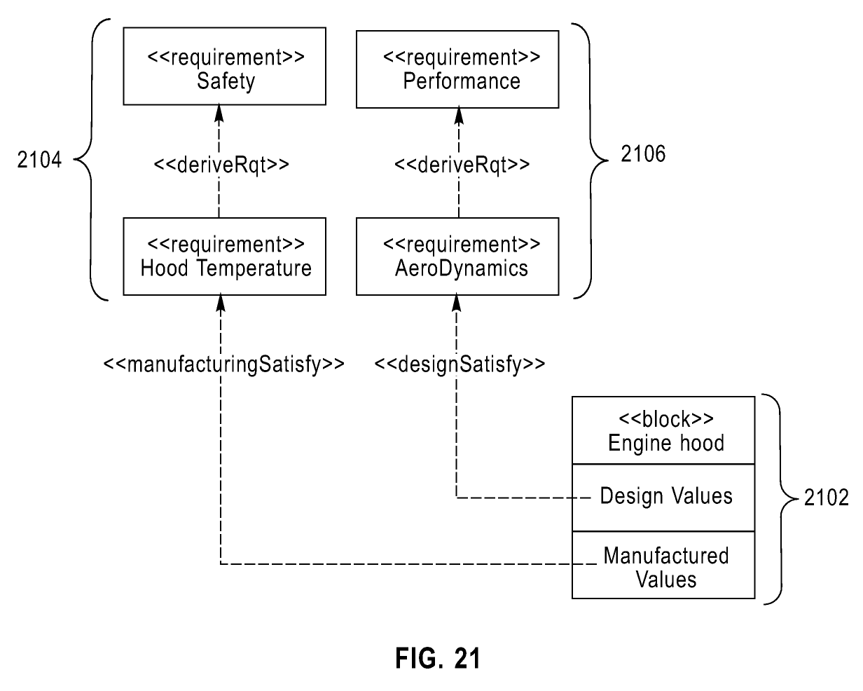

Consider the following example. A new safety requirement that requires an engineering design change is added to a manufactured product composed of electrical and mechanical components. The new requirement constrains the operating temperature of the engine hood to remain below a certain value, while satisfying shape specification to keep aerodynamics properties. In this scenario, the designer can instruct the engineers to measure such a value on existing product such that it can be imported in the conceptual design model using the method, system and/or apparatus of the present disclosure. Once the value is available, the designer can use it to produce an updated design specification. FIG. 21 below illustrates this scenario using a SysML diagram. The access to manufactured properties 2104 at the conceptual stage 2102 creates a feedback loop that offer opportunities to refine the product specification 2106. Using the method, system and/or apparatus of the present disclosure, designer can update the design specification 2106 using measurements from the manufactured product 2104.

The disclose tool provides a method of detecting inconsistency between constraints in the system-level design and the external reference values in the detailed manufacturing design information by extending the requirement traceability (“satisfy” association) and tracing the associations, based on the requirements described in the model and the derived detailed manufacturing design information. The data structure of the concept model is extended to have mappings from the model elements (system blocks and associated properties) to the corresponding external reference values. The concept model is further extended to represent associations that enable to trace requirements and blocks in the concept model to the satisfied constraints/rules description, which is one of the concept model elements.

An interactive user interface enables building mappings from the system blocks to the corresponding BoM nodes (for instance, assembly parts). Similarly, properties associated to each block are mapped to individual external reference values.

The disclosed tool may also enable deriving constraints and rules based on the mapped concept model elements, and confirming that the constraints are satisfied and the rule is not violated by evaluating the constraint/rule expressions using the external reference values.

The disclosed tool also provides a method of detecting invalidation among the mappings by identifying a pattern about consistency of system-level design elements, BoM structure, and the relationship(s). The concept model is represented as a tree structure in one embodiment, for example, forming a tree by tracing specific associations (functional decomposition, inclusion, and so on) to descendent nodes of the model elements from the top level node mapped from the top level parts in BOM. Searches may be performed to determine whether or not any inversion structure exist in the whole, by investigating the relationship between the tree nodes of the concept model and the tree nodes of BoM.

The system and method of the present disclosure may be implemented and run on a general-purpose computer or computer system. The computer system may be any type of known or will be known systems and may typically include a processor, memory device, a storage device, input/output devices, internal buses, and/or a communications interface for communicating with other computer systems in conjunction with communication hardware and software, etc.

The terms “computer system” and “computer network” as may be used in the present application may include a variety of combinations of fixed and/or portable computer hardware, software, peripherals, and storage devices. The computer system may include a plurality of individual components that are networked or otherwise linked to perform collaboratively, or may include one or more stand-alone components. The hardware and software components of the computer system of the present application may include and may be included within fixed and portable devices such as desktop, laptop, server. A module may be a component of a device, software, program, or system that implements some “functionality”, which can be embodied as software, hardware, firmware, electronic circuitry, or etc.

The embodiments described above are illustrative examples and it should not be construed that the present invention is limited to these particular embodiments. Thus, various changes and modifications may be effected by one skilled in the art without departing from the spirit or scope of the invention as defined in the appended claims.

We claim:

1. A system for using design specification and measurements on manufactured products in conceptual design model, comprising:
a conceptual model extender module operable to map one or more model elements to corresponding external reference values, the corresponding external reference values including at least design specification values and manufacturing properties associated with said one or more model elements;
a presenter module operable to present said one or more model elements mapped to corresponding external reference values; and
a importer module operable to import said external reference values from one or more external systems for mapping to said one or more model elements.

2. The system of claim 1, further including:
a tracer module operable to trace one or more satisfy associations related to said one or more model elements.

3. The system of claim 2, farther including:
a mapper module operable to synchronize a plurality of mappings of one or more model elements to corresponding external reference values.

4. The system of claim 3, further including:
a consistency manager module operable to determine consistency of said synchronized mappings.

5. The system of claim 1, further including:
a change manager module operable to detect changes in said external reference values and provide notification of the changes.

6. The system of claim 1, wherein said one or more external reference systems includes mechanical design artifacts, electronic design artifacts, software design artifacts, engineering bill of material, manufacturing bill of material, or service bill of material, or combinations thereof.

7. The system of claim 1, wherein the presenter modules further includes a graphical user interface.

8. A method of using design specification and measurements on manufactured products in conceptual design model, comprising:
extending a concept model to include mappings of one or more model elements to corresponding reference values, the corresponding external reference values including at least design specification values and manufacturing properties associated with said one or more model elements;
importing said corresponding external reference values from one or more external systems for mapping to said one or more model elements; and
presenting said mappings of one or more model elements to corresponding reference values to a user.

9. The method of claim 8, further including:
implementing dependencies among said one or more model elements and corresponding reference values.

10. The method of claim 9, further including:
detecting changes in said corresponding reference values; and
posting notification of the detected the changes.

11. The method of claim 8, wherein the step of extending includes extending data structure of the concept model to have said mappings.

12. The method of claim 8, wherein the step of extending further includes extending the concept model to represent one or more associations that enable tracing of one or more requirements and blocks in the concept model to one or more rules.

13. The method of claim 8, further including:
providing an interactive user interface operable to allow a user to build said mappings.

14. The method of claim 8, further including:
providing an interactive user interface operable to allow a user to build mappings to one or more bill of material nodes.

15. The method of claim 8, further including:
allowing a user to derive one or more constraints based on said mappings.

16. The method of claim 8, wherein said concept model is represented as a tree structure.

17. A program storage device readable by a machine, tangibly embodying a program of instructions executable by the machine to perform a method of using design specification and measurements on manufactured products in conceptual design model, comprising:
extending a concept model to include mappings of one or more model elements to corresponding reference values, the corresponding external reference values including at least design specification values and manufacturing properties associated with said one or more model elements;
importing said corresponding external reference values from one or more external systems for mapping to said one or more model elements; and
presenting said mappings of one or more model elements to corresponding reference values to a user.
